(19) United States
(12) Patent Application Publication
(10) Pub. No.: US 2009/0051178 A1
(43) Pub. Date: Feb. 26, 2009

(54) Vehicle bumper protector

(76) Inventor: Warren Redden, Spartanburg, SC (US)

Correspondence Address: JUAN J. LIZARRAGA, 909 POYDRAS STREET, SUITE 2300, NEW ORLEANS, LA, 70112-1010, US

(21) Appl. No.: 12/228,605

(22) Filed: Aug. 14, 2008

Related U.S. Application Data
(60) Provisional application No. 60/965,686, filed on Aug. 21, 2007.

(51) Int. Cl. B60R 19/44

(52) U.S. Cl. 293/142

(57) ABSTRACT

A protector for the rear bumper of a towing vehicle with a hitch ball to prevent damage caused by the concave coupling receiver on a trailer tongue consisting of a resilient panel notched for placement on the draw bar of a towing hitch mechanism. The panel will be provided with notches to fit various classes of towing mechanism as well as an opening for removing and handling the protector.

This application claims priority from U.S. Provisional application Ser. No. 60/965686 (“the '686 application”) filed Aug. 21, 2007. The '686 application is incorporated herein by reference.

### BACKGROUND OF THE INVENTION

The present invention relates to an improvement in protecting the rear bumper of vehicles with a ball type towing hitch. More specifically, the invention relates to protecting the rear bumper of a towing vehicle from damage by the coupler of a trailer during the engagement or disengagement of the trailer to the towing vehicle.

A typical towing hitch mechanism consists of a hitch ball mounted on the rear of the towing vehicle and a concave coupling receiver mounted on a trailer tongue at the front of the trailer. The coupling receiver fits over the hitch ball and is held in place by a clamp built into the coupling receiver.

In practice, this hitching method requires that the hitch ball be brought within inches of the coupling receiver to engage the hitch mechanism. Because of the weights involved, the ball is usually brought directly below the coupling receiver, which is then lowered onto the hitch ball by a trailer jack. Once in place on the hitch ball, the coupling receiver is clamped in place. To accomplish this it is usually necessary to back the towing vehicle to place the hitch ball in position below the coupling receiver. Because of the lack of visibility and other factors such as uneven and sloping ground, it is very easy and quite likely that the coupling receiver will hit the towing vehicle bumper adjacent to the hitch ball, causing damage to the bumper or license plate in proximity of the hitch ball.

It is clearly desirable to have a device to protect the bumper of a towing vehicle and several devices have been developed in an attempt to solve this problem, but these devices are bulky and unsightly. Since towing a trailer is generally a limited activity for most vehicles, it is desirable to provide a device to protect the bumper which can be quickly installed when towing a trailer and quickly removed when not.

### SUMMARY OF THE INVENTION

It is a primary objective of the present invention to provide a device for protecting the rear bumper of a towing vehicle from damage caused by the coupling receiver on the trailer tongue where such device comprises a protective resilient panel notched to slide on and off the draw bar of a towing hitch mechanism.

It is a further object of the invention that the inventive device is quickly installed when needed and quickly removed when not needed, and is of a size and weight that can be easily handled by an individual and stored in the towing vehicle when not in use.

It is a further object of this invention that it be applicable to various towing load Classes.

### BRIEF DESCRIPTION OF THE DRAWINGS

FIG. 1 is a perspective view of a typical towing hitch mechanism with one embodiment of the inventive vehicle bumper protector.

FIG. 2 is a perspective view of a typical towing hitch mechanism without the inventive vehicle bumper protector.

FIG. 3 is a perspective view of one embodiment of the inventive vehicle bumper protector in place on a towing vehicle.

FIG. 4 is a perspective view of an alternative embodiment of the inventive vehicle bumper protector in place over a draw bar.

FIG. 5 is an exploded view of the hitch ball portion of a towing hitch mechanism on the towing vehicle.

FIG. 6 is a perspective view of one embodiment of the inventive vehicle bumper protector.

FIG. 7 is a cross section of the inventive vehicle bumper protector in place on the towing vehicle.

FIG. 8 is a perspective view of an alternative embodiment of the inventive vehicle bumper protector

### DETAILED DESCRIPTION OF THE INVENTION

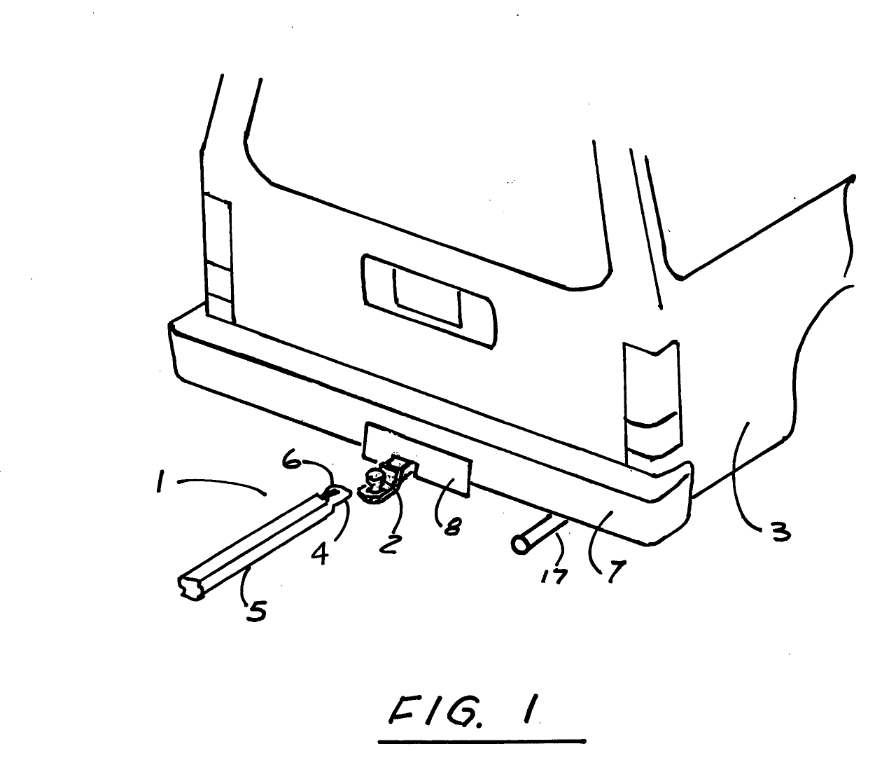

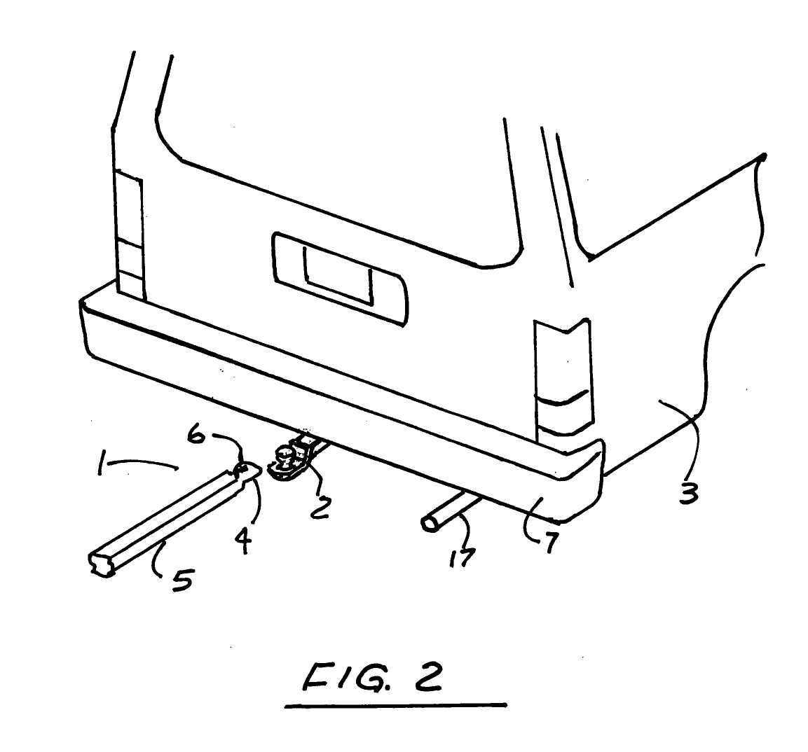

FIGS. 1 and 2 both depict a typical towing vehicle 3 and a towing hitch mechanism 1 with a hitch ball 2 mounted on the towing vehicle 3, a concave coupling receiver 4 mounted on the forward end of the trailer tongue 5 extending from a trailer which is not shown. A clamp 6 is shown for clamping the concave coupling receiver 4 to the hitch ball 2. In FIG. 1 one embodiment of the vehicle bumper protector 8 is shown in place between the hitch ball 2 and the bumper 7 of the towing vehicle 3. The exhaust pipe 17 of the towing vehicle 3 is also shown for clarity.

As shown in FIG. 1, the vehicle bumper protector 8 prevents the concave coupling receiver 4 on the forward end of the trailer tongue 5 from hitting the bumper 7 during engagement or disengagement of the trailer to the towing vehicle as would be possible without the vehicle bumper protector 8, as depicted in FIG. 2.

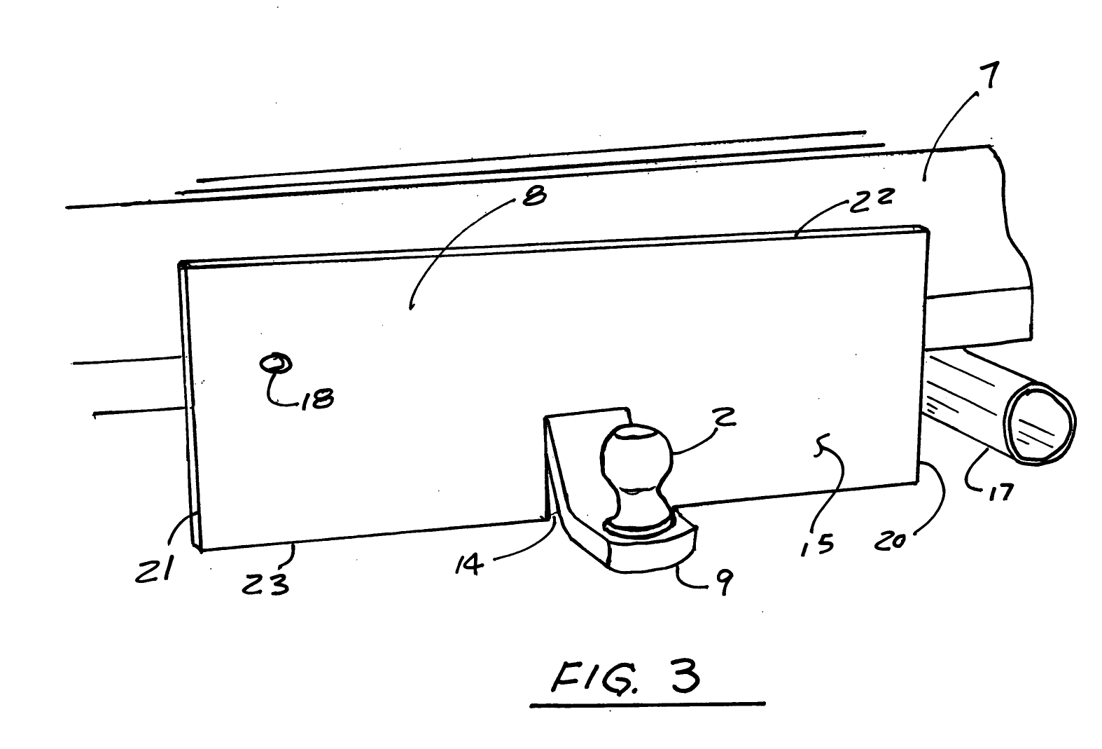

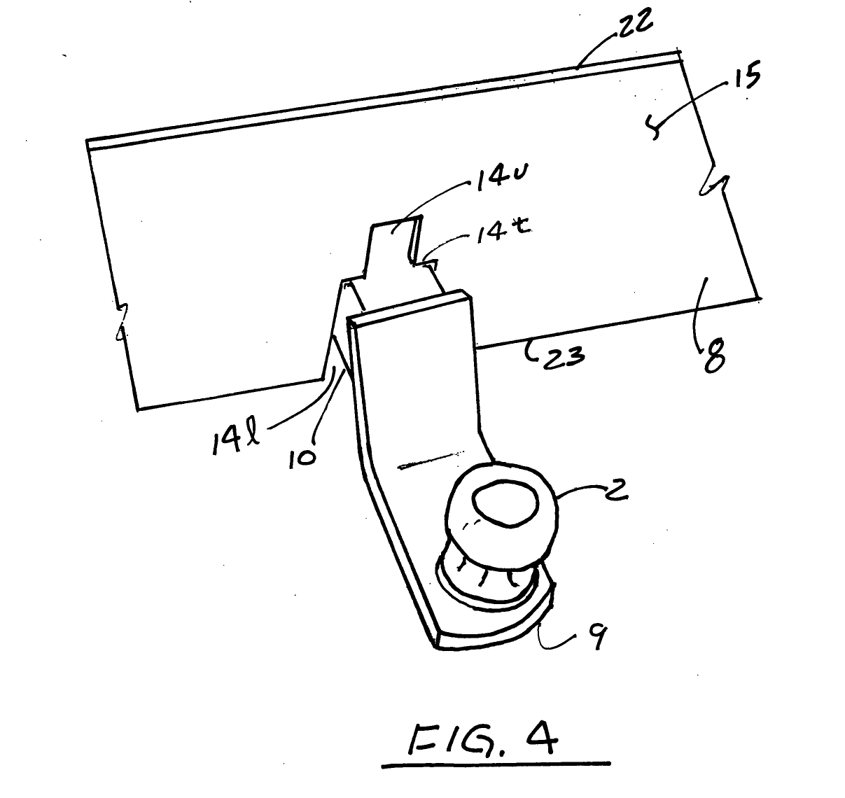

FIGS. 3 and 4 show perspective views of two embodiments of the inventive bumper protector 8 in place on a towing vehicle 3 between the bumper 7 and the hitch ball 2. The inventive bumper protector 8 has a top edge 22, a bottom edge 23, a right end 20 and a left end 21. The inventive bumper protector 8 also has an outer surface 15 and a reverse surface 16 not seen in FIGS. 3 and 4. As shown in both FIGS. 3 and 4, the hitch ball is mounted on an extending bar support 9. Although shown in a general rectangular shape, it is not intended that the bumper protector 8 be limited to that configuration.

In FIG. 4 the extending bar support is shown in position on the draw bar 10 which extends rearward from under the bumper 7 of the towing vehicle 3. In alternative arrangements of towing hitch mechanisms 1, the draw bar 10 may extend rearward as an integral part of the bumper 7.

On the embodiment of the bumper protector 8 shown in FIG. 3 a notch 14 of general rectangular shape extends vertically from the bottom edge 23. In the embodiment of bumper protector 8 shown in FIG. 4, a lower notch 14L of general rectangular shape extends vertically from the bottom edge 23. However, an upper notch 14L extends vertically from the top edge 14T of lower notch 14L. As can be seen in FIG. 4, the lower notch 14L of vehicle bumper protector 8 allows the vehicle bumper protector 8 to slide vertically both on and off of the draw bar 10. However, if the draw bar 10 was rated at a lower towing class and hence was of smaller dimension, the vehicle bumper protector 8 would slide vertically on and off the draw bar 10 but in and out of the upper notch 14U. For example, the upper notch 14U could be used for Class I and II towing mechanisms and the lower notch 14L would be used for Class III towing mechanisms

In common practice, draw bars 10 are typically manufactured from structural steel tubing of square or rectangular cross section. Hence, it is intended the notch 14 be 4842 configured to fit over a standard draw bar 10. In the embodiment shown in FIG. 4, the lower notch 14L would be configured to fit over a larger standard draw bar such as Class III, while the upper notch 14U would be configured to fit over a smaller standard draw bar such as for Class I and II.

Also shown in FIGS. 3 and 4 is a finger opening 18 for use in removing and handling the vehicle bumper protector 8, as well as storage.

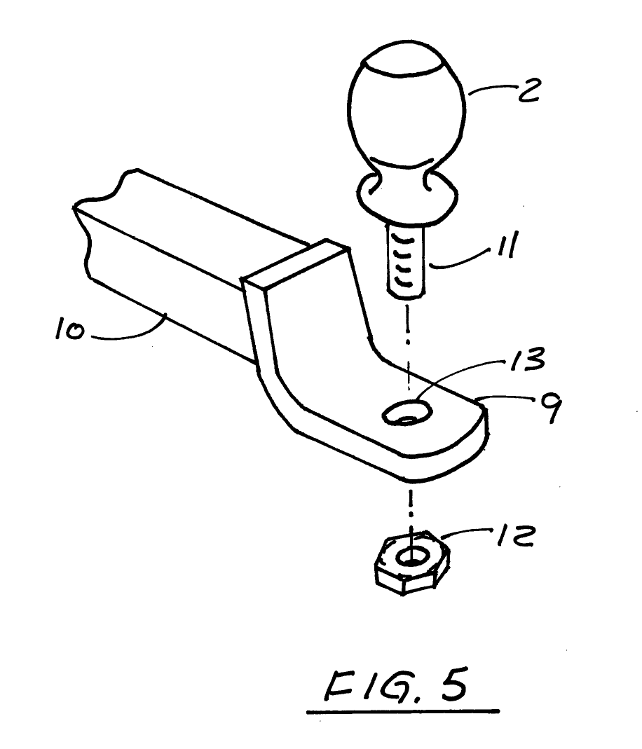

FIG. 5 depicts an exploded view of a hitch ball portion of a towing mechanism 1. The hitch ball 2 has a lower threaded portion 11, which is inserted into an aperture 13 in the extending bar support 9. A hitch ball retaining nut 12 is threaded onto the lower threaded portion 11 of the hitch ball 2 to fixedly attach the hitch ball 2 to the extending bar support 9. The extending bar support 9 is fixedly welded to the draw bar 10, which extends rearward from the towing vehicle 3. While not shown, it is understood that the draw bar 10 is fixedly attached to the chassis or frame of the towing vehicle 3 with sufficient strength to match the required towing load.

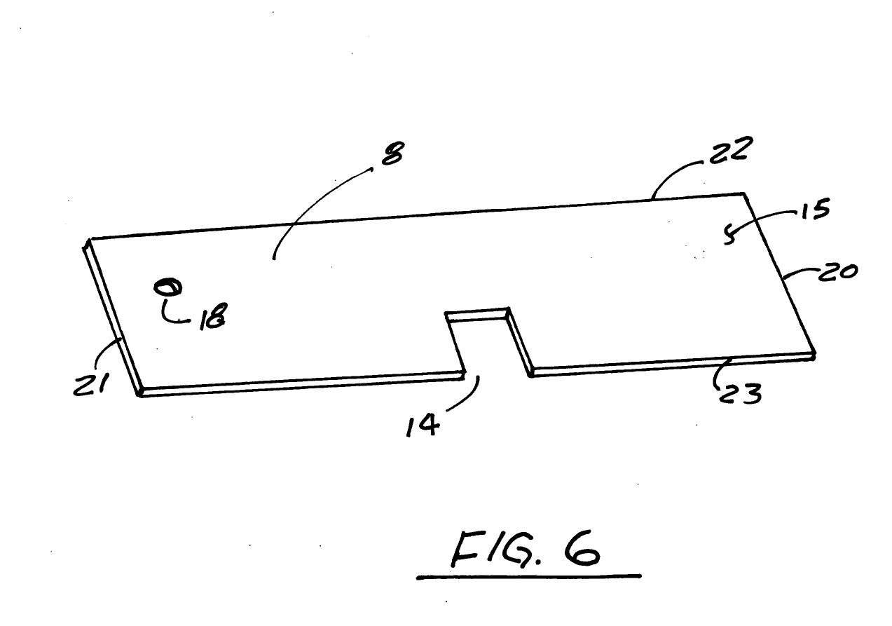

FIG. 6 depicts a perspective view of one embodiment of the vehicle bumper protector 8 showing the elements previously shown in FIGS. 3 and 4. A vertical notch 14 of general rectangular shape is provided on the bottom edge 23 to allow placement of the vehicle bumper protector 8 over a draw bar 10. Also depicted in FIG. 6 is an outer surface 15, a right end 20, a left end 21, a top edge 22 and a bottom edge 23. An opening 18 is also shown.

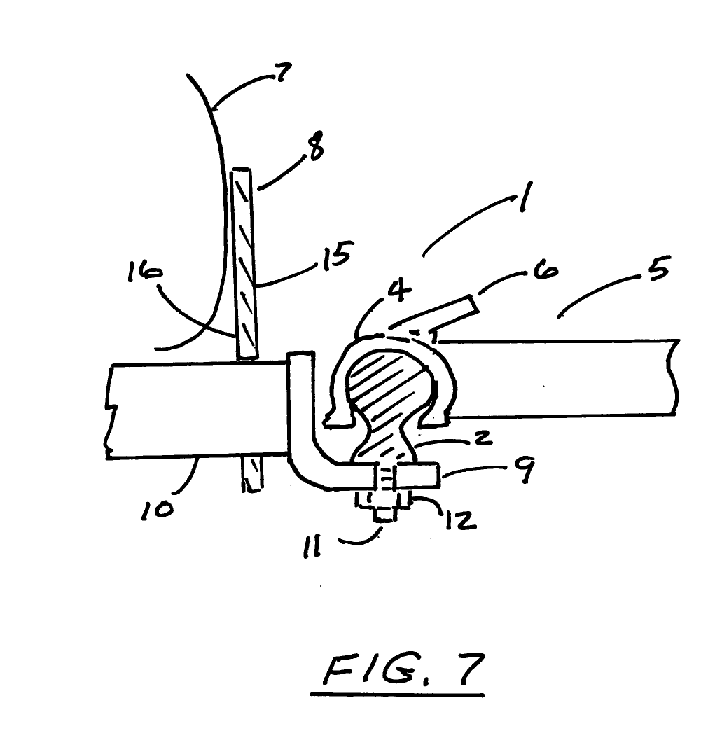

FIG. 7 is a cross sectional view of the vehicle bumper protector 8 in place on the towing vehicle 3 with a typical towing hitch mechanism 1. The vehicle bumper protector 8 has a reverse surface 16 in contact with the bumper 7. Other elements of the towing hitch mechanism 1 are depicted to show the draw bar 10, the extending bar support 9 with the hitch ball 2 fixedly attached by the hitch ball retaining nut 12 threaded on the threaded portion 11. In place on the hitch ball 2 is the concave coupling receiver 4 mounted on the front end of the trailer tongue 5. The concave coupling receiver 4 is secured on the hitch ball 2 by a clamp 6.

As can be seen in FIG. 7, the vehicle bumper protector 8 will prevent the trailer tongue 5 with concave coupling receiver 4 from hitting the bumper 7 during the process of placing the hitch ball 2 in position to receive the concave coupling receiver 4 or moving the concave coupling receiver 4 on the trailer tongue 5 to align with the hitch ball 2.

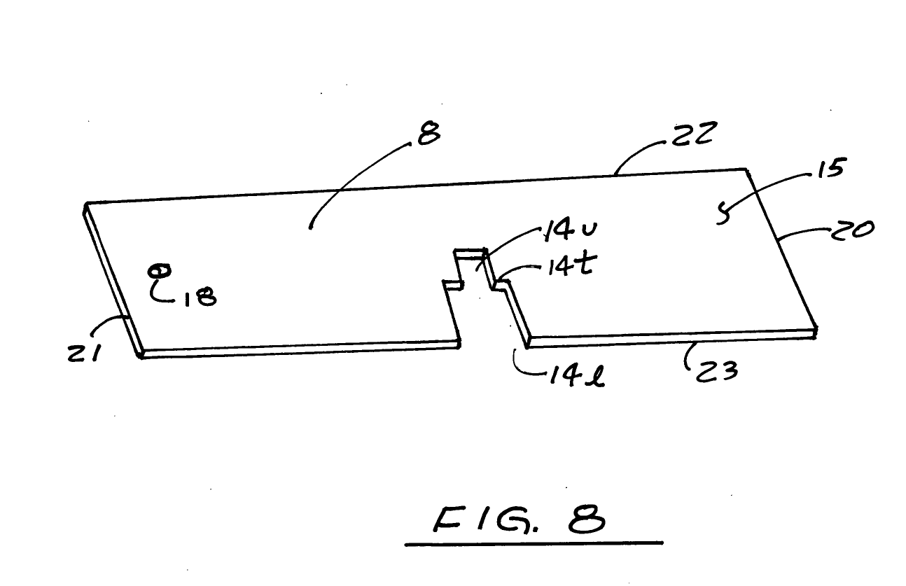

FIG. 8 depicts a perspective view of an alternative embodiment of the vehicle bumper protector 8 showing the elements previously shown in FIG. 4. A lower vertical notch 14L of general rectangular shape is provided on the bottom edge 23 to allow placement of the vehicle bumper protector 8 over a draw bar 10. Extending vertically from the top edge 14T of lower notch 14L is an upper notch 14U of general rectangular shape. Also depicted in FIG. 8 is an outer surface 15, a right end 20, a left end 21, a top edge 22 and a bottom edge 23. An opening 18 is also shown.

It is intended that the vehicle bumper protector 8 be a resilient panel manufactured of such material that will sustain the impact of a concave coupling receiver 4 on a trailer tongue 5 without damaging the bumper 7 of the towing vehicle 3. One suitable material would be flat exterior plywood between ⅜ to ½ inch thick. It is contemplated however, that other materials with similar properties may be substituted therefor.

Towing hitch mechanisms are typically rated according to the towing load as Class I, Class II, Class III, etc., with Class I being the lowest load rating. It is intended that the inventive vehicle bumper protector 8 be adapted to fit various load rated towing hitch mechanisms either singly or in combination.

In one embodiment of the vehicle bumper protector 8, the configuration would be rectangular with the distance between the right end 20 and the left end 21 being 24 inches and the distance between the top edge 22 and the bottom edge 23 being 9 inches. The notch 14 would be centered on the bottom edge 23 with a typical vertical height of 2 inches. For Class I and Class II applications, the width of the notch 14 would be 1¼ inches and for Class III applications, the width of the notch 14 would be 2 inches. The hole 18 would typically be 1.75 inches in diameter, vertically centered between the top edge 22 and the bottom edge 23 and approximately 1 inch in a horizontal direction from the left end 21.

In an alternative embodiment of the vehicle bumper protector 8, the configuration would be rectangular with the distance between the right end 20 and the left end 21 being 24 inches and the distance between the top edge 22 and the bottom edge 23 being 9 inches. The lower notch 14L would be centered on the bottom edge 23 with a vertical height of 2 inches and a width of 2 inches. The upper notch 14U would be centered at the top of the lower notch 14L with a vertical height of 1¼ inches and a width of 1¼ inches. The hole 18 would typically be 1.75 inches in diameter, vertically centered between the top edge 22 and the bottom edge 23 and approximately 1 inch in a horizontal direction from the left end 21.

1. A bumper protector for a vehicle fitted with a towing ball on an extending bar support mounted on a draw bar, comprising a resilient panel with an outer surface, a reverse surface, a right end, a left end, a top edge, a bottom edge, at least one opening extending from the outer surface to the reverse surface, at least one lower notch with a top notch edge extending vertically from the bottom edge of the bumper protector, said lower notch sized to fit over the draw bar.

2. The bumper protector of claim 1, further comprising an upper notch of less width than the lower notch, extending vertically from the top notch edge of the lower notch and sized to fit a draw bar of lesser size than that which the lower notch is sized to fit.

3. The bumper protector of claim 1, where the resilient panel is exterior plywood at least ½ inch thick.

4. The bumper protector of claim 2, where the resilient panel is exterior plywood at least ½ inch thick.

5. The bumper protector of claim 1, where the resilient panel is exterior plywood at least ⅜ inch thick.

6. The bumper protector of claim 2, where the resilient panel is exterior plywood at least ⅜ inch thick.

7. The bumper protector of claim 1 wherein the resilient panel would be rectangular with the distance between the right end and the left end being 24 inches and the distance between the top edge and the bottom edge being 9 inches and the lower notch would be centered on the bottom edge with a vertical height of 2 inches and a width of 1¼ inches, and the opening would be 1.75 inches in diameter, vertically centered between the top edge and the bottom edge and 1 inch in a horizontal direction from the left end.

8. The bumper protector of claim 1 wherein the resilient panel would be rectangular with the distance between the right end and the left end being 24 inches and the distance between the top edge and the bottom edge being 9 inches and the lower notch would be centered on the bottom edge with a vertical height of 2 inches and a width of 2 inches, and the opening would be 1.75 inches in diameter, vertically centered between the top edge and the bottom edge and 1 inch in a horizontal direction from the left end.

9. The bumper protector of claim 7 where the resilient panel is exterior plywood at least ½ inch thick.

10. The bumper protector of claim 8 where the resilient panel is exterior plywood at least ½ inch thick.

11. The bumper protector of claim 7 where the resilient panel is exterior plywood at least ⅜ inch thick.

12. The bumper protector of claim 8 where the resilient panel is exterior plywood at least ⅜ inch thick.

13. The bumper protector of claim 2 wherein the resilient panel would be rectangular with the distance between the right end and the left end being 24 inches and the distance between the top edge and the bottom edge being 9 inches and the lower notch would be centered on the bottom edge with a vertical height of 2 inches and a width of 2 inches, the upper notch would be centered on the upper edge of the lower notch with a vertical height of 1¼ inches and a width of 1¼ inches, and the opening would be 1¾ inches in diameter, vertically centered between the top edge and the bottom edge and 1 inch in a horizontal direction from the left end.

14. The bumper protector of claim 13 where the resilient panel is exterior plywood at least ½ inch thick.

15. The bumper protector of claim 13 where the resilient panel is exterior plywood at least ⅜ inch thick.
